(19) United States
(12) Patent Application Publication
(10) Pub. No.: US 2016/0335405 A1
(43) Pub. Date: Nov. 17, 2016

(54) METHOD AND SYSTEM FOR ANALYZING DIGITAL ACTIVITY

(71) Applicant: ZOKAY LTD., Mississauga (CA)

(72) Inventors: Sergey PERUNOV, Mississauga (CA); Robert BEGHIAN, Mississauga (CA)

(21) Appl. No.: 15/154,936

(22) Filed: May 13, 2016

Related U.S. Application Data
(60) Provisional application No. 62/160,652, filed on May 13, 2015.

(51) Int. Cl. G06F 19/00; G06N 99/00

(52) U.S. Cl. CPC G06F 19/345; G06N 99/005

(57) ABSTRACT

A method for determining a user's well-being based on a user's digital activity, the method having the steps of: associating said user with a unique identifier; logging each instance said device accesses said digital services or content; determining a type of said digital services or content being accessed by said user; capturing user generated content and device generated content; forming core data associated with said user derived from data associated with each of said steps; and analyzing said core data to determine whether elements within said core data are indicative of distress, and providing an alert when said elements exist.

### CROSS-REFERENCE TO RELATED APPLICATIONS

This application claims the benefit of priority to U.S. Provisional Application Ser. No. 62/160,652, filed on May 13, 2015.

### FIELD OF THE INVENTION

The present invention relates to methods and systems for monitoring device usage and digital network activity, such as Internet activity and social network activity.

### DESCRIPTION OF THE RELATED ART

The need to communicate with other human beings is an essential part of being human, and human beings have always found ways to keep in touch. In a hyper-connected world, and having a plethora of communication tools, such as, snail mail, telephones, email, text messaging, video calls, messaging, it can be worrisome when a friend or loved one is unheard from for a lengthy period of time. The situation is further exacerbated when the concerned person's numerous attempts to communicate with the unresponsive person are largely ignored, or unrequited, and the concerned person is unable to easily determine the well-being of the unresponsive friend or loved one. Naturally, the concerned person continues to repeatedly call and message the unresponsive person, or resorts to calling or messaging mutual acquaintances to find out if the unresponsive person is well. However, depending on the situation, it is not always possible to get a response from the mutual acquaintances which further exacerbates the mounting stress, worry and fear. The lack of responsiveness to communication requests by the unresponsive person may be attributed to a plethora of legitimate reasons, such as, being in a meeting, or the ringer on mobile device being disabled, or set to a low volume; a lost or stolen mobile device; or perhaps they are simply focussed on work. Most often than not, despite being unresponsive to communication requests, the unresponsive person remains routinely active on various digital services, devices and social media. Therefore, if the concerned person was aware that the unresponsive individual was unable to respond due to legitimate reasons, the stress, worry and fear could be avoided.

One attempt to solve this problem is the STATUS mobile app, developed by Egomotion Corp., that automatically determines the user's status based on their mobile phone behavior and shares it with their friends. (e.g., in a meeting, driving, at home, out of town, etc.). However, this is an incomplete solution since it relies on the mobile phone being functional, and it does not attempt to define a norm for the user, or measure deviations from that norm.

Yet another proposed solution is the LAST SEEN ONLINE tool in Facebook Messenger™, developed by Facebook, Inc. of Menlo Park, Calif., U.S.A., which indicates the last recorded time an individual was active on Facebook. Unfortunately, this tool may be not relied upon as it has been known to output false positives due to the nature of its architecture. In addition, this tool may only be useful if the user has a Facebook account and uses it regularly, also does not attempt to define a norm for the user or measure deviations from that norm.

It is an object of the present invention to mitigate or obviate at least one of the above-mentioned disadvantages.

### SUMMARY OF THE INVENTION

In one of its aspects, there is provided a method for determining a user's well-being based on a user's digital activity, the method having the steps of: associating said user with a unique identifier; logging each instance said device accesses said digital services or content; determining a type of said digital services or content being accessed by said user; capturing user generated content and device generated content; forming core data associated with said user derived from data associated with each of said steps; and analyzing said core data to determine whether elements within said core data are indicative of distress, and providing an alert when said elements exist.

In another of its aspects, there is provided a system comprising a computer-readable medium having a first set of program instructions executable by a processor to cause said processor to learn user behaviour from user activity data associated with a user during a training phase, said system comprising:

a user device communicatively coupled to a network;

a plurality of service providers communicatively coupled to said network, and accessible by said user device;

a data collection engine configured to request and receive unstructured user activity data from said plurality of service providers and user device usage data to compose an aggregated user activity dataset;

a perceptions modeling engine comprising:
a quantitative component modeler having a first set of program instructions in a computer-readable medium, said first set of program instructions executable by a processor to cause said processor to quantify user activity data to model user activity by generating a perceptions map with a numerical value of zero or 1 to form a first set of perceptions; and
a qualitative component modeler having a second set of program instructions in a computer-readable medium, said second set of program instructions executable by a processor to cause said processor to at least discover any patterns, keywords, and frequency of words, themes or phrases that may indicate distress; and determine whether the frequency of use popular positive keywords that have been used in past postings has diminished, or whether those positive works are now non-existent, to form a second set of perceptions; and

whereby weights are assigned to each of said generated perceptions; and said weights are randomised and a total estimated concern score for each of said periods is computed, and said total estimated concerned scores are summed to obtain a composite estimated concern score; and

whereby said first set of perceptions and said second set of perceptions reflect quantitative and qualitative measures useful for predicting said digital user's activity and well-being.

In yet another of its aspects, there is provided a method for predictive modelling of user behaviour based on digital activity associated with a user, said method comprising the steps of:

(a) receiving unstructured user activity data from a plurality of sources and forming an aggregated user activity dataset;

(b) normalizing said aggregated user activity dataset;

(c) determining a first set of time frames with digital activity and a second set of time frames without digital activity, and when the length of each of said second set of time frames without said digital activity exceeds a predetermined threshold then said second set of time frames are associated with an alert period having a high concern score, and said first set of time frames are associated with a non-alert period having a low concern score,

(d) generating perceptions of user behavior from said aggregated user activity dataset;

(e) assigning weights to each of said generated perceptions;

(f) randomizing said weights and calculating a total estimated concern score for each of said time frames based said generated perceptions, and summing said total estimated concerned scores to obtain a composite estimated concern score;

(g) determining a delta between said composite estimated concern score and said concern score from step (a);

(h) repeating steps (f) and (g) to determine optimal values for said weights; and

whereby said the well-being of said user can be predicted.

In yet another of its aspects, there is provided a computer-readable medium having program instructions executable by a processor to cause said processor to learn user behaviour from aggregated digital activity data associated with a user by performing the steps of at least:

(a) receiving said aggregated user activity dataset derived from a plurality of sources;

(b) normalizing said aggregated user activity dataset;

(c) determining a first set of time frames with digital activity and a second set of time frames without digital activity, and when the length of each of said second set of time frames without said digital activity exceeds a predetermined threshold then said second set of time frames are associated with an alert period having a high concern score, and said first set of time frames are associated with a non-alert period having a low concern score,

(d) generating perceptions of user behavior from said aggregated user activity dataset;

(e) assigning weights to each of said generated perceptions;

(f) randomizing said weights and calculating a total estimated concern score for each of said time frames based said generated perceptions, and summing said total estimated concerned scores to obtain a composite estimated concern score;

(g) determining a delta between said composite estimated concern score and said concern score from step (a);

(h) repeating steps (f) and (g) to determine optimal values for said weights; and whereby said the well-being of said user can be predicted.

In yet another of its aspects, there is provided a well-being platform comprising:

a user device communicatively coupled to a network;

a plurality of service providers communicatively coupled to said network, and accessible by said user device;

a data collection engine configured to request and receive unstructured user activity data from said plurality of service providers and user device usage data to compose an aggregated user activity dataset;

a concern check module configured to determine periods of digital inactivity and associate said periods with a high concern score, while periods of digital activity are associated with a low concern score;

a perceptions modeling engine configured to generate perceptions of said user behavior from said aggregated user activity dataset by assigning weights to each of said generated perceptions; randomizing said weights and calculating a total estimated concern score for each of said periods, and summing said total estimated concerned scores to obtain a composite estimated concern score; and to execute program instructions to iteratively find the optimal model parameters for said user by comparing said composite estimated concern score to a real concern score; and

whereby said concern check module further requests and receives up-to-date unstructured user activity data from said plurality of service providers and user device usage data to compose an up-to-date aggregated user activity dataset;

applying said optimal model parameters for said user to said up-to-date aggregated user activity data to identify lengthy time frames of digital inactivity and assigning a high up-to-date concern score, while other time frames are assigned said low up-to-date concern score to generate up-to-date perceptions for user and a composite up-to-date concern score, and thereby determine the up-to-date well-being of said user.

In yet another of its aspects, there is provided a perceptions modeling engine comprising:

a quantitative component modeler having a first set of program instructions in a computer-readable medium, said first set of program instructions executable by a processor to cause said processor to quantify user activity data to model user activity by generating a perceptions map with a numerical value of zero or 1 to form a first set of perceptions;

a qualitative component modeler having a second set of program instructions in a computer-readable medium, said second set of program instructions executable by a processor to cause said processor to at least discover any patterns, keywords, and frequency of words, themes or phrases that may indicate distress; and determine whether the frequency of use popular positive keywords that have been used in past postings has diminished, or whether those positive works are now non-existent, to form a second set of perceptions; and

whereby said first set of perceptions and said second set of perceptions reflect quantitative and qualitative measures useful for predicting said digital user's activity and well-being.

Advantageously, the method and system aggregates user data from a plurality of sources, such as social networking sites, search providers, video streaming services, music streaming services, websites, network-connected devices, such as mobile devices, smartwatches, wearable devices, and so forth, to determine a cross-service representation of the user's unique digital activity. Accordingly, the method and system is capable of monitoring a user's data usage, including frequency of use of digital services or devices, and determine the digital services or devices the individual is most active on, to provide an activity quotient. In addition, the method and system is capable of determining the well-being of an individual based on the individual's digital activity, and that determination may be shared with third parties, such as friends, family, employers, educational institutions, insurance providers, and so forth. Also, the personality and interests of the individual may be determined based on the individual's digital activity; and the individual may be matched, introduced to, or connected to other individuals who share a similar personality or similar interests based on the individual's digital signature. In addition, an individual's mental health may also be monitored based on their digital activity.

### BRIEF DESCRIPTION OF THE DRAWINGS

Several exemplary embodiments of the present invention will now be described, by way of example only, with reference to the appended drawings in which:

FIG. 1 is a top-level component architecture diagram of an exemplary system for analyzing digital activity;

FIG. 2 shows a high level flow diagram illustrating an exemplary process steps for predicting a user's well-being;

FIG. 3 shows a graph illustrative of a calculation of a delta between actual concern value and an estimated concern value; and

FIG. 4 is a dataflow diagram for determining a concern value based on aggregated user data.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

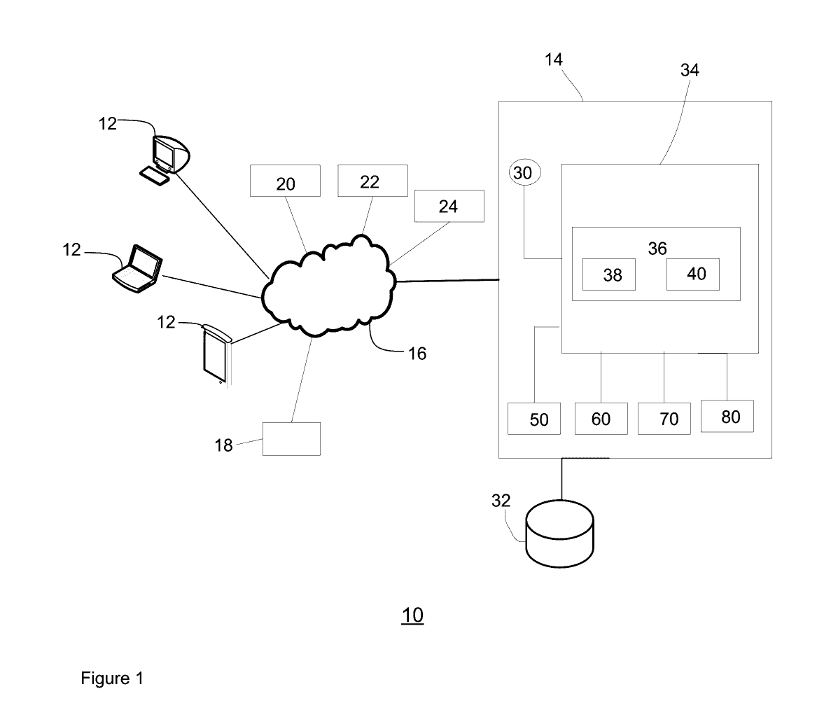

FIG. 1 shows a top-level component architecture diagram of an exemplary system, generally identified by reference numeral 10, for analyzing digital activity, particularly social media activity, pertaining to users on a well-being platform. System 10 generally includes one or more user devices 12 coupled to computing system 14 via communications network 16, such as the Internet, and/or any other suitable network. Computing system 14, may be a server which may include, but are not limited to: a personal computer, a server computer, a series of server computers, a mini computer, and a mainframe computer.

User devices 12 access online content from internet content providers 18 and social networks 20, 22, 24. Internet content providers 18 distribute content such as, news, blogs, information and entertainment, leisure activities, and other material. Social networks 20, 22, 24, can be any social media or different types of information sources including, but not limited to, networks, websites, or computer enabled systems. For example, a social media network may be Facebook®, Twitter®, LinkedIn®, Instagram™ Snapchat™, or other similar computer enabled systems or websites. Other types of online content may include video streaming services, such as Netflix®, HBO Now® and Amazon®; music streaming services, such as, Spotify™, Rhapsody™, Pandora™ and Google Music®; and communication services such as Skype™ and WhatsApp™ including RSS feeds, and web feeds.

Users may also provide user generated content and machine generated content via user devices 12. In one example, wearable devices, such as Fitbit™, and smart garments, which track movement, geolocation, distance, calories burnt, and monitor sleep cycles, transfer the acquired data and metadata to server 14 for further analysis and reporting. User-generated content may include, e.g., email, Short Messaging Service (SMS) texts, browsing the internet, contacts from a contact list utilized during a call session, most-used applications, most navigated destinations, most frequently emailed contacts from a contact list, etc. Machine-generated content may include various applications usage time-based and hardware/software activity-based metrics, e.g., application launch time, operating system, user device details, application shutdown time, concurrently running applications, application switching, geolocation, and metadata.

Each user is assigned a unique identifier by server 14 and user data collection engines 30 associated with each of the distributors of online content, such as content providers 18 and social networks 20, 22, 24, record each instance a particular service is accessed as an access event. Accordingly, each access event is associated with a date stamp and time stamp, and duration of the access event may also be determined. The user's personal data and access events from a plurality of user data collection engines 30 is aggregated to provide details of the user's online usage from different perspectives. Server 14 is associated with one or more databases 32, which may be any type of data repository or combination of data repositories, which store records or other representations of data associated with the user and access events, among others. User activity is fundamentally unstructured data, and it is assumed that any form of activity unequivocally means that the user is at a minimum alive. A global norm for user activity may not be readily definable, as some individuals post multiple posts to social networks 20, 22, 24 in one day, while others, for example, will only post on a weekly basis. The individual may also favor one particular social network 22, for example, over other social networks 20 and 24, and therefore may be hyper-active on that favourite social network 22, and relatively inactive on the other social networks 20 and 24. Also, the user preferences may shift over time resulting in changes activity levels on the social networks 20, 22, 24. Additionally, the substance of the user generated content, such as posts or language within those posts, may be at times more meaningful than the mere frequency of posts, and may therefore be indicative of distress.

Analytics module 34 receives usage data from user data collection engines 30, and analytics module 34 comprises a sequence of instructions that are executed by a processor on server 14 to analyze the unstructured user data and determine a user's well-being. Analytics module 34 comprises perceptions modeling engine 36 which includes quantitative component modeler 38 and qualitative component modeler 40. Quantitative component modeler 36 quantifies the collected data associated with the users' digital activities from user data collection engines 30 in a uniform manner to model user activity by generating a perceptions map with a numerical value of zero or 1 (“0” or “1”), to form a first set of perceptions. For example, one perception may reflect time elapsed since last known user activity; while more complex perceptions may take account of time of day, day of the week, etc., as users may be more or less active during work hours or weekends). Qualitative component modeler 40 analyzes the user generated content i.e. social networking postings or search queries to form a second set of perceptions. Qualitative component modeler 40 discovers any patterns, keywords, and frequency of words, themes or phrases that may indicate distress; or conversely determine whether the frequency of use popular positive keywords that have been used in past postings has diminished, or whether those positive works are now non-existent. Accordingly, these sets of perceptions reflect quantitative and qualitative measures that may be material to predicting the user's activity and well-being.

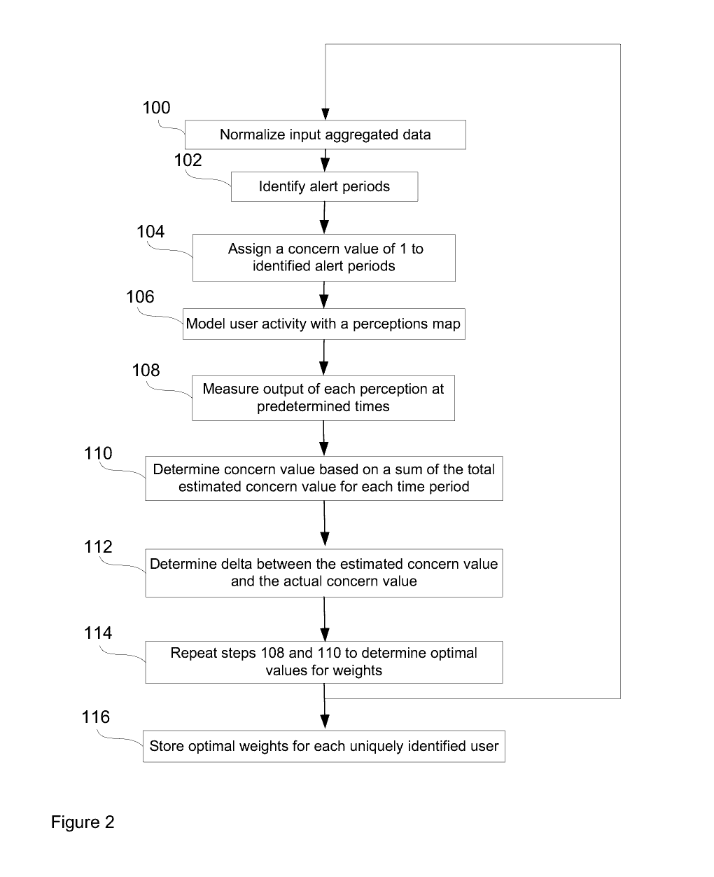

Referring now to FIGS. 2, 3 and 4, there is shown a high level flow diagram illustrating exemplary process steps for predicting a user's well-being by analytics module 34. Generally, analytics module 34 includes program instructions executable to discover irregular activity patterns that may be indicative of distress, thereby triggering an alert or alarm. The process begins with a learning phase or training phase, in which the unstructured input data is received from data collection engines 34. In exemplary step 100, the unstructured input data is normalized, and perception engine 36 receives the normalized data and initiates the assembly of a user activity model. The time frames corresponding to user activity are registered, and in step 102, the lengthiest time frames representing lack of digital activity are noted, and any lengthy time frames without digital activity provide cause for concern or alarm, and therefore they are referred to as “alert periods”. In step 104, every alert period is assigned a value or score of “1”, indicative of a high level of concern, while a concern value of “0” is assigned to every time interval that is not considered part of an alert period. Accordingly, the concern score is used as a proxy for an indication of the individual's well-being, with the assumption that if the user's well-being was at risk, then their digital activity patterns would differ significantly from their norm.

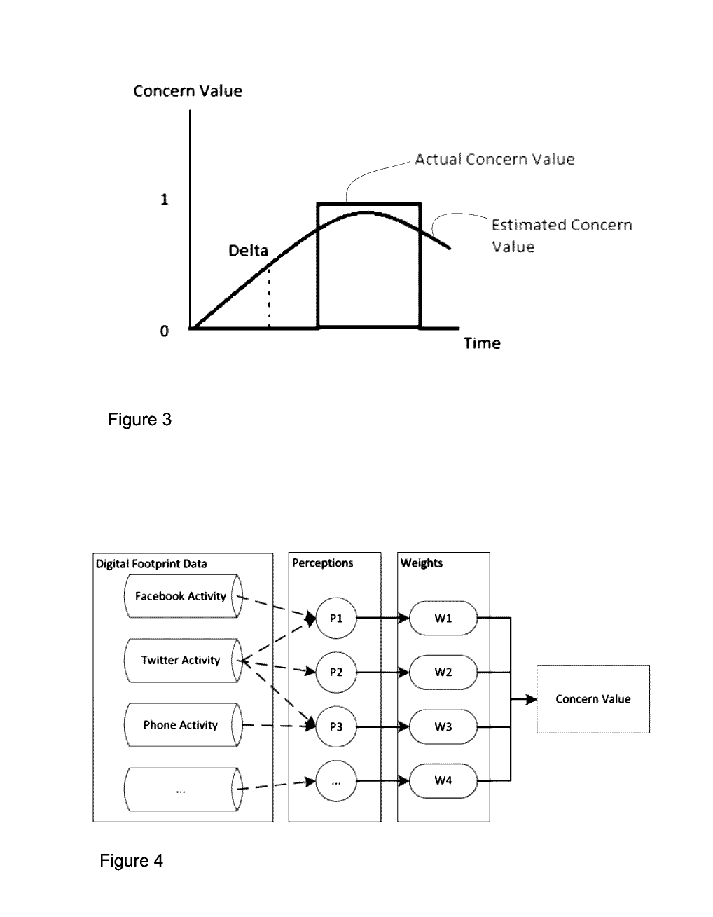

Next, a plurality of perceptions (P1, P2, P3, Pn) is generated from the aggregated data from multiple sources (step 106), e.g. Facebook, Twitter, or phone activity. The output of each perception is measured at regular intervals throughout the training period (step 108), and a weight (W1, W2, W3, Wn) is assigned to each perception P1, P2, P3, Pn, as shown in FIG. 4. Next, the weights assigned to each perception are randomized, and the total estimated concern value is calculated for each time period based on the model's perceptions, and the sum of these concern values indicates the overall concern value (step 110). Once the estimated concern values for each time interval in consideration are calculated, the total delta between the estimated values and the actual concern values determined in step 102 is computed, as shown in FIG. 3 (step 112). In step 114, the process repeats from step 108 to step 110 iteratively as the weights are mutated by a decreasing coefficient, in which mutations are rejected if the delta has grown, and retained if the delta has decreased. After a predefined number of mutations the weights converge to the optimal values. In step 116, the optimal weights pertaining to each user are associated with the user's unique identifier and stored in database 32. In order to keep up with the user's drift in their digital activity and capture any deviations from digital activity norms, the above-noted steps are executed at predetermined times, on a regular basis.

Once a user's behaviour is learned and recorded, system 10 may be used to determine if the user has been consistent with their normal digital activity patterns, and thereby infer their well-being via concern check module 50. For example, when an individual is concerned about a friend or a loved one that has not been heard back from, or has not responded to communication requests, the individual may send a query to concern check module 50 to determine the status of the unresponsive friend or loved one. Concern check module 50 comprises executable program instructions to request the most recent aggregated data derived the unresponsive user's use of devices and digital services from user data collection engines 30 and dispatches the user data to analytics module 34 for processing. Perception modelling engine 36 processes the received user data via the above-noted steps to learn the unresponsive user's recent digital activity patterns. Next, a comparison is made between the recently learned digital activity patterns and the stored normal digital activity patterns or threshold patterns to determine whether the unresponsive user has been deviating from their normal digital activity routine. Analytics module 34 also determines the degree to which the pattern has been deviated from and derives a ‘concern level’ from these deviations. Typically, irregular activity patterns signify concern, and the level of concern is assigned a numerical value in the range zero to one (“0” to “1”), with “1” representing the highest amount of concern, as previously described. Concern check module 50 thus provides up-to-date concern values based on the most recent aggregated user data, and a concern level of level of “1” may prompt the concerned person to escalate their efforts to determine the true well-being of the unresponsive user by engaging law enforcement personnel.

In another implementation a user may ‘friend’ other users in a manner similar to adding friends, followers on social media, thereby creating a circle of friends on the well-being platform. The user may configure concern check module 50 to automatically notify these connected friends via alerts when a high concern level detected, thereby forming a virtual and automated ‘buddy system’. Alternatively, the user may proactively “check in” to the platform to share with their circle of friends their status or well-being. In one example, a positive well-being status update may artificially reduce the concern level being calculated for their profile.

In yet another implementation the aggregated user data may be used by personality module 60 to determine a user's personality. To-date, personality determination tools use either surveys and quizzes or social media language usage to determine personality traits. Therefore, these tools require users to be verbal on social media or take the time to fill out quizzes in order to monitor their own personality traits. Personality module 60 includes executable program instructions to analyze the aggregated data, to discover features (words, phrases or topics) in the data that are correlated with each of the 5 attributes in the Five Factor Model of personality: agreeableness, conscientiousness, openness, neuroticism and extraversion. The ‘score’ for each attribute is analogous to the strength of the correlations between the features extracted from the data, and the personality traits mentioned above. Personality module 60 learns correlations between all digital activity and personality traits by using a baseline of correlations between the personality traits and the language used while on social networks.

While a baseline of correlations between language usage and personality traits is available through various research projects that have been undertaken by the World Well-Being Project (WWBP) of the University of Pennsylvania, personality module 60 advantageously correlates general digital activity (including non-verbal activity such as ‘liking’ an article on Facebook, retweeting a tweet, sending an email, or reading an email, etc.) with the Five Factor Model traits. Therefore, personality module 60 significantly improves upon the WWBP model by eliminating the reliance on verbal feature extraction. Advantageously, personality module 60 learns the correlation by extracting non-verbal features from the core data of users whose personality scores have already been determined through either verbal feature extraction and correlation, or through a direct personality test administered through an online survey. This gives personality module 60 the capability of providing, for future users, a personality profile even if there are no verbal features present in their aggregated data.

In another implementation matching module 70 uses the aggregated user data involves to discover users who share similar data features, approximating similarity in personality and behavior. Currently, for friendships or romantic relationships initiated on the internet, a consumer must rely on descriptions of the prospective friend or romantic partner (i.e. a prospect) to make a decision on whether to make contact or not. This method is rife with the potential for ‘false advertising’ as prospects can fully optimize their profiles by way of writing carefully-crafted descriptions or providing photos that are overly favourable and do not accurately represent the prospect. Therefore, there is no empirical a priori way of knowing whether a prospect is an appropriate match. Matching module 70 comprises executable program instructions to analyze the aggregated data of all users and extract a set of features that are indicative of personality and behavior. Each user's features are then checked against those of all other users to find users who closely match each other.

The analysis performed by matching module 70 is based on historical behaviours and verbal expressions, which can be much more representative of the prospect's actual self rather than the carefully self-curated profiles that are rampant on friendship or dating services sites. Closely matched users are then presented to each other as potential friends, with an option to contact each other privately. For example, a user may have access to a prospect's personality results in order to make an informed decision regarding the appropriateness of the suggested match. In another example, businesses or other organizations can use matching module 70 to profile and segment their customers based on personality, volume of data usage, or well-being, as described above. In addition, employees may be profiled, segmented and monitored in a similar manner. Businesses, law enforcement, or other organizations can use digital activity norms for individuals to serve as identity verification.

In yet another implementation, activity metering module 80 uses the aggregated data from the user data collection engines 30 to generate views of the usage of the various services, websites, apps, and the user device 12 from different perspectives. The usage may be represented with user interface elements such as charts and icons on user device 12. Through these charts and icons, users are able to find out information such as: what services do they spend most time on? When during the day are they most active online? How much do they visit or use a given digital service during work hours?

User device 12 may be in the form of any kind of general processing structure, and may for example include any device, such as, a personal computer, laptop, computer server, handheld user device (e.g. personal digital assistant (PDA), mobile phone, tablet, smartphone, smartwatch, wearable device). The general-purpose processing structure comprises, for example, a processing unit, such as processor, system memory. The system also includes as input/output (I/O) devices coupled to the processor via an I/O controller. The input/output (I/O) devices include, for example, a keyboard, mouse, trackball, microphone, touch screen, a printing device, display screen, speaker, etc. A communications interface device provides networking capabilities using Wi-Fi, and/or other suitable network format, to enable connection to shared or remote drives, one or more networked computers, or other networked devices, via the communications network 16. The components of computer system may be coupled by an interconnection mechanism, which may include one or more buses (e.g., between components that are integrated within a same machine) and/or a network (e.g., between components that reside on separate discrete machines). The interconnection mechanism enables communications (e.g., data, instructions) to be exchanged between system components.

The processor executes sequences of instructions contained in memory, such as a machine readable medium. The machine readable medium includes any mechanism that provides (i.e., stores and/or transmits) information in a form accessible by a machine (e.g., a computer, network device, personal digital assistant, a smartphone, any device with a set of one or more processors, etc.). For example, machine readable media includes recordable/non-recordable media (e.g., read only memory (ROM); random access memory (RAM); magnetic disk storage media; optical storage media; flash memory devices; a hard disk drive, etc.), as well as electrical, optical, acoustical or other forms of propagated signals (e.g., carrier waves, infrared signals, digital signals, etc.). The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used. The operating system may be, for example, iPhone OS (e.g. iOS), Windows Mobile, Google Android, Symbian, or the like.

Server computer 14 includes a computer system with elements similar to those described above with reference to user device 12. Server computer 14 may be a web server (or a series of servers) running a network operating system, examples of which may include but are not limited to: Microsoft® Windows® XP Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

Server computer 14 may execute a web server application, examples of which may include but are not limited to: Microsoft IIS, Novell Webserver™, or Apache® Webserver, that allows for HTTP (i.e., HyperText Transfer Protocol) access to server computer 14 via network 16 (Webserver is a trademark of Novell Corporation in the United States, other countries, or both; and Apache is a registered trademark of Apache Software Foundation in the United States, other countries, or both).

Database 32 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention. Alternatively, database 32 is communicatively coupled to server computer 14.

The user devices 12 and computer server 14 may communicate with each other using network-enabled code. Network enabled code may be, include or interface to, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMWL), Wireless Markup Language (WML), Java™, Java™ Beans, Enterprise Java™ Beans, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

The communications network 16 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1. A system having a computer-readable medium having a set of program instructions executable by a processor to cause said processor to learn user behaviour from user activity data associated with a user during a training phase, said system comprising:
a user device communicatively coupled to a network;
a plurality of service providers communicatively coupled to said network, and accessible by said user device;
a data collection engine configured to request and receive unstructured user activity data from said plurality of service providers and user device usage data to compose an aggregated user activity dataset;
a perceptions modeling engine comprising:
a quantitative component modeler having a first set of program instructions in a computer-readable medium, said first set of program instructions executable by a processor to cause said processor to quantify user activity data to model user activity by generating a perceptions map with a numerical value of zero or 1 to form a first set of perceptions; and
a qualitative component modeler having a second set of program instructions in a computer-readable medium, said second set of program instructions executable by a processor to cause said processor to at least discover any patterns, keywords, and frequency of words, themes or phrases that may indicate distress; and determine whether the frequency of use popular positive keywords that have been used in past postings has diminished, or whether those positive works are now non-existent, to form a second set of perceptions; and
whereby weights are assigned to each of said generated perceptions; and said weights are randomised and a total estimated concern score for each of said periods is computed, and said total estimated concerned scores are summed to obtain a composite estimated concern score; and
whereby said first set of perceptions and said second set of perceptions reflect quantitative and qualitative measures useful for predicting said digital user's activity and well-being.

2. The system of claim 1, further comprising said perceptions modeling engine configured to receive said aggregated user activity dataset and execute program instructions to iteratively find the optimal model parameters for said user by comparing said composite estimated concern score to a real concern score; and a concern check module configured to determine periods of digital inactivity and associate said periods with a high concern score and are indicative of said user's well-being at risk, while periods of digital activity are associated with a low concern score.

3. The system of claim 2, wherein said perceptions and said composite concern score are calculated over a predetermined time period to form a digital activity baseline indicative of a norm for said user.

4. The system of claim 3, wherein following said predetermined training phase, said set of program instructions executable by a processor cause said processor to determine an up-to-date well-being of said user during a monitoring phase by:
requesting and receiving up-to-date unstructured user activity data from said plurality of service providers and user device usage data to compose an up-to-date aggregated user activity dataset;
applying said optimal model parameters for said user to said up-to-date aggregated user activity data to identifying lengthy time frames of digital inactivity and assigning a high up-to-date concern score, while other time frames are assigned said low up-to-date concern score to generate up-to-date perceptions for user and a composite up-to-date concern score.

5. The system of claim 4, wherein said low composite up-to-date concern score is indicative of a safe well-being of said user; and wherein said high composite up-to-date concern score is indicative of risk to said well-being of said user.

6. The system of claim 5, wherein said concern check module issues an alert to a third party recipient upon determination of said high composite up-to-date concern score.

7. The system of claim 6, wherein said third party recipient comprises at least one of a friend, patent, guardian, family member, employer, institution, insurance provider, healthcare professional.

8. The system of claim 7, wherein said plurality of service providers comprises at one of a social network provider, telecommunications provider, network provider.

9. The system of claim 8, wherein said aggregated user activity data comprises website data, mobile app data, mobile network usage data, WI-FI connectivity data, and user device usage data.

10. The system of claim 9, wherein said aggregated user activity data comprises user generated content and user device generated content, said user generated content comprising at least one of an email, Short Messaging Service (SMS) texts, browser history, Internet activity, telephone call history, fitness or activity tracking updates, contacts from a contact list utilized during a call session, most-used applications, most navigated destinations, most frequently emailed contacts from a contact list; and user device generated content comprising at least one of application usage, application launch time, application shutdown time, concurrently running applications, application switching and call metadata.

11. A method for predictive modelling of user behaviour based on digital activity associated with a user, said method comprising the steps of:
(a) receiving unstructured user activity data from a plurality of sources and forming an aggregated user activity dataset;
(b) normalizing said aggregated user activity dataset;
(c) determining a first set of time frames with digital activity and a second set of time frames without digital activity, and when the length of each of said second set of time frames without said digital activity exceeds a predetermined threshold then said second set of time frames are associated with an alert period having a high concern score, and said first set of time frames are associated with a non-alert period having a low concern score,
(d) generating perceptions of user behavior from said aggregated user activity dataset;
(e) assigning weights to each of said generated perceptions;
(f) randomizing said weights and calculating a total estimated concern score for each of said time frames based said generated perceptions, and summing said total estimated concerned scores to obtain a composite estimated concern score;
(g) determining a delta between said composite estimated concern score and said concern score from step (a);
(h) repeating steps (f) and (g) to determine optimal values for said weights; and
whereby said the well-being of said user can be predicted.

12. The method of claim 11, wherein in step (h) said weights are mutated by a decreasing coefficient, and mutations are rejected if said delta increases, and retained if said delta decreases, and said optimal values for said weights are determined following a predefined number of mutations.

13. The method of claim 12, wherein said optimal values are associated with said user and stored in a non-transitory computer-readable medium.

14. The method of claim 13, wherein said steps (a) to (h) correspond to a learning phase and said optimal values are applied to an up-to-date aggregated user activity dataset to produce an up-to-date concern score associated with said user to determine an up-to-date well-being of said user.

15. The method of claim 14, wherein an alert is issued to a third party recipient when said up-to-date concern score is high.

16. The method of claim 14, wherein said aggregated user activity dataset is analyzed to determine a personality of said user by discovering a predetermined set of features correlated with at least one of: agreeableness; conscientiousness; openness; neuroticism; and extraversion.

17. The method of claim 16, wherein said user having said personality discovers at least another user having a similar personality and behaviour.

18. The method of claim 17, wherein said user having said personality is assigned to a segment to receive targeted messaging based on said personality and said aggregated user activity dataset.

19. The method of claim 18, wherein said user's mental health is monitored based on at least one of said aggregated user activity dataset, said personality and said up-to-date concern score to output a mental health status.

20. The method of claim 19, wherein said mental health status is transmitted to at least one third party recipient.

21. A well-being platform comprising:
a user device communicatively coupled to a network;
a plurality of service providers communicatively coupled to said network, and accessible by said user device;
a data collection engine configured to request and receive unstructured user activity data from said plurality of service providers and user device usage data to compose an aggregated user activity dataset;
a concern check module configured to determine periods of digital inactivity and associate said periods with a high concern score, while periods of digital activity are associated with a low concern score;
a perceptions modeling engine configured to generate perceptions of said user behavior from said aggregated user activity dataset by assigning weights to each of said generated perceptions; randomizing said weights and calculating a total estimated concern score for each of said periods, and summing said total estimated concerned scores to obtain a composite estimated concern score; and to execute program instructions to iteratively find the optimal model parameters for said user by comparing said composite estimated concern score to a real concern score; and
whereby said concern check module further requests and receives up-to-date unstructured user activity data from said plurality of service providers and user device usage data to compose an up-to-date aggregated user activity dataset;
applying said optimal model parameters for said user to said up-to-date aggregated user activity data to identify lengthy time frames of digital inactivity and assigning a high up-to-date concern score, while other time frames are assigned said low up-to-date concern score to generate up-to-date perceptions for user and a composite up-to-date concern score, and thereby determine the up-to-date well-being of said user.

22. The well-being platform of claim 21, wherein said low composite up-to-date concern score is indicative of a safe well-being of said user; and wherein said high composite up-to-date concern score is indicative of risk to said well-being of said user.

23. The well-being platform of claim 22, wherein said concern check module issues an alert to said third party recipient upon determination of said high composite up-to-date concern score.

24. A perceptions modeling engine comprising:
a quantitative component modeler having a first set of program instructions in a computer-readable medium, said first set of program instructions executable by a processor to cause said processor to quantify user activity data to model user activity by generating a perceptions map with a numerical value of zero or 1 to form a first set of perceptions;
a qualitative component modeler having a second set of program instructions in a computer-readable medium, said second set of program instructions executable by a processor to cause said processor to at least discover any patterns, keywords, and frequency of words, themes or phrases that may indicate distress; and determine whether the frequency of use popular positive keywords that have been used in past postings has diminished, or whether those positive works are now non-existent, to form a second set of perceptions; and
whereby said first set of perceptions and said second set of perceptions reflect quantitative and qualitative measures useful for predicting said digital user's activity and well-being.

25. The perceptions modeling engine of claim 24, wherein said first set of perceptions is associated with at least one of elapsed time since last known user activity and determining user activity for each time of day and for each day of the week.

26. The perceptions modeling engine of claim 24, wherein said second set of perceptions is associated with determining the substance of user generated content within said user activity data.
